(19) United States
(12) Patent Application Publication
(10) Pub. No.: US 2014/0147710 A1
(43) Pub. Date: May 29, 2014

(54) SEPARATOR FOR A LITHIUM ION BATTERY AS WELL AS A LITHIUM ION BATTERY CONTAINING THE SEPARATOR

(71) Applicant: Li-Tec Battery GmbH, Kamenz (DE)

(72) Inventor: Tim Schaefer, Harztor (DE)

(73) Assignee: Li-Tec Battery GmbH, Kamenz (DE)

(21) Appl. No.: 14/090,733

(22) Filed: Nov. 26, 2013

Related U.S. Application Data
(60) Provisional application No. 61/730,566, filed on Nov. 28, 2012.

(30) Foreign Application Priority Data
Nov. 28, 2012 (DE) 10 2012 023 294.2

(51) Int. Cl. H01M 2/16

(52) U.S. Cl. CPC H01M 2/166
USPC 429/50; 429/247; 429/252; 429/144; 429/246

(57) ABSTRACT

Subject-matter of the invention is a separator for a lithium ion battery which separates the positive and the negative electrode of the lithium ion battery from one another and which is permeable to lithium ions, characterized in that the separator comprises at least one silica, preferably in the form of a xerogel, and at least one carbon component, as well as a lithium ion battery containing said separator.

### CROSS-REFERENCE TO RELATED APPLICATIONS

The present application claims the benefit of U.S. Provisional Patent Application Ser. No. 61/730,566, filed Nov. 28, 2012, the entire content of which is incorporated herein by reference. The present application also claims priority to German Patent Application 10 2012 023 294.2, filed Nov. 28, 2012, the entire content of which is incorporated herein by reference.

### DESCRIPTION

The present invention relates to a separator for a secondary battery, particularly a separator for a lithium ion battery.

Due to their high energy density and high capacitance, secondary batteries, particularly lithium ion batteries, can be used to power portable electronic devices. Such batteries are moreover used in tools, electrically operated automobiles and hybrid-drive automobiles. So that they will be suited to these uses, the batteries should have high voltage, high capacitance and prolonged longevity with a high degree of safety and reliability. Yet it is known that high voltage can compromise the battery's safety and reliability. For example, the separator in the battery can be adversely altered. This can result in the unwanted growing of Li crystals, so-called Li dendrites or “lithium whiskers,” through the separator. These then connect the anode and the cathode of the battery together, which results in the short circuiting of the battery. This can lead to the battery failing and/or the battery's reliability and safety being compromised.

Separators exhibiting high resistance to dendrites or whisker formation are already being sold by the Evonik AG company in Germany under the trade name of “Separion®”. They can for example be manufactured by means of methods as disclosed in EP 1 017 476 B1, WO 2004/021477 and WO 2004/021499. These separators comprise a fibrous nonwoven of non-woven polymeric fibers coated with a ceramic material which is conductive to lithium ions.

Modifying the properties of separators in lithium ion batteries by incorporating additives and/or fillers into the separators is also proposed.

US 2010/0099022 A1 discloses a separator for a secondary battery having a non-aqueous electrolyte, for example a lithium ion battery exhibiting high thermal resistance and electrical capacitance. A separator comprising a porous film having a heat-resistant layer and a shut-down layer laminated onto each other is thereby inserted into the battery, whereby the heat-resistant layer comprises a filler of spherical particles, wherein in addition to nitrides, carbides, hydroxides, sulfates and carbonates, oxides such as silica, alumina or titanium dioxide are proposed as filler. Due to its chemical stability, the use of alumina is hereby preferred in accordance with this printed publication.

US 2012/0094184 A1 discloses separators for a lithium ion battery based on polymeric fibers in which inorganic particles selected from silica gel, alumina, boehmite, etc. are introduced to improve thermal resistance.

DE 102 55 124 A1 discloses that pyrogenic silica can be used in separators of lithium ion batteries, whereby however the use of such a substance in a separator can lead to impairing the battery's long-term stability. According to this DE 102 55 124 A1 art, pyrogenic silica can react exothermically with battery components such as e.g. a lithiated electrode or the conducting salt.

The object of the present invention is to provide a separator for a secondary battery, particularly for a lithium ion secondary battery, which further improves on the properties of known separators and which enables the providing of a battery which remains as stable, and thus durable, as possible even at high voltages.

This object is accomplished by a separator as defined in claim 1. Preferential further developments of the separator are defined in the claims dependent on claim 1.

In accordance with a first aspect, the invention relates to a separator for a lithium ion battery which separates the positive and the negative electrode of the lithium ion battery from one another and which is permeable to lithium ions,

characterized in that

the separator comprises at least one silica and at least one carbon component.

In one embodiment, in addition to the silica and carbon components, the separator comprises sulfur which is at least partially, preferentially substantially, at an oxidation state of 0, −2 or +6.

The inventors have found that a silica combined with a carbon component or a silica combined with a carbon component and sulfur which is at least partially, preferentially substantially, at an oxidation state of 0, −-2 or +6 can effectively prevent or at least minimize the formation of lithium dendrites or lithium whiskers in the separator of a lithium ion battery.

The inventors have surprisingly also found that in a case of moisture penetrating into the lithium ion battery, the separator can effectively bind the moisture, whereby the possible forming of hydrogen fluoride from an electrolyte containing fluorine can also be effectively prevented or at least minimized.

The inventors have further found that a disadvantageous formation of gas in the battery, for example upon the battery being damaged, can also be prevented or at least minimized as the silica and the carbon component can absorb gases.

The inventors have furthermore found that the dimensional stability of a lithium ion battery using the inventive separator can be improved since the frequently observed age-related swelling or dimensional changes to the battery respectively can be minimized. Similarly, distortions in the battery attributable to the manufacturing process are minimized or advantageously corrected.

Secondary batteries comprising the inventive separator can thus exhibit prolonged longevity and a high degree of safety, which is extremely advantageous with respect to their use in tools, electrically operated automobiles and hybrid-drive automobiles.

The terms defined in the following are defined within the meaning of the invention.

### Separator

The term “separator” denotes the element of a lithium ion battery which separates the anode and the cathode of the battery from one another. The separator used for the battery needs to be permeable to lithium ions so as to ensure lithium ion transport between the positive and the negative electrode. On the other hand, the separator should insulate against or at least poorly conduct electrons.

In accordance with the invention, the separator comprises one or more silica and one or more carbon components. A carbon component is thereby a modification of the carbon element (“C”).

The term “silica” encompasses all the oxyacids of silicon known to one skilled in the art of the general formula H₂ₙ+₂SiₙO₃ₙ+₁, thus for example monosilica (orthosilica) Si(OH)₄, disilica (pyrosilica) (HO)₃Si—O—Si(OH)₃, and trisilica (HO)₃Si—O—Si(OH)₂—O—Si(OH)₃. The term also encompasses cyclic silicas such as e.g. cyclotrisilica and cyclotetrasilica of the general molecular formula [Si(OH)₂—O—]ₙ as well as long-chain silica of the general molecular formula H₂SiO₃, [Si(OH)₂—O—]n), also referred to as metasilic acid. The term also encompasses amorphous colloids (silica sols) and silicas such as pyrogenic silicas of the SiO₂ formula. The term further also encompasses salts of the acids, preferably the alkaline salts, wherein alkali is preferably Li, as well as the term “silica gel.”

The term “silica” also encompasses silicas in the form of a xerogel. In accordance with known methods, such gels can be produced from suitable precursor compounds containing silicon, for instance silicon alkoxy compounds, in a sol-gel process, wherein the sol phase is hydrolyzed and condensed, thereby forming a moist yet firm gel phase. By drying the gel phase, which generally does not occur under supercritical conditions, the fluid is extracted from the gel, thus producing a dried, monolithic matrix exhibiting an open network of pores (“xerogel”). The dried gel monolith can then also be calcinated to form a firm, vitreous monolith of interconnected pores. This monolith can be solidified even further, for example by sintering, whereby the monolith is transformed into a glass or a ceramic. Of course it is also possible to reduce the xerogel to a desired particle size for the inventive use, preferably by grinding.

In one embodiment, the xerogel is in particle form, whereby the particles are of spherical shape.

In a further embodiment, the particles of the xerogel can exhibit a stretched, elongated form.

Preferential silicas have a BET surface area of 5-800, preferentially 10-500, particularly preferentially 50-300 m²/g.

Suitable silicas are commercially available or can be produced according to known methods, for example according to the method disclosed in DE 101 51 777 A1.

Silicas as marketed as “Sipermat®” and “Sident®” by the Evonik company (Germany) have proven to be particularly well suited in the sense of the invention.

The term “carbon” or “carbon component” encompasses all known modifications and types of elemental carbon. In one embodiment, the carbon can be graphite, amorphous carbon, glassy carbon, graphene, activated carbon, carbon black, carbon nanotubes, carbon nanofoam, fullerene or mixtures of two or three of same.

In one embodiment, the term “carbon”or “carbon component”encompasses carbon modifications which do not conduct electrons or more poorly conduct them than for example graphite. One embodiment utilizes known amorphous carbon or glassy carbon.

In a further embodiment, in addition to silica and carbon, the separator comprises sulfur or a sulfur compound.

In one embodiment, in addition to silica and carbon, the separator comprises sulfur which is at least partially, preferentially substantially, at an oxidation state of 0, −2 or +6.

In one embodiment, the term “sulfur” denotes elemental sulfur (oxidation state 0). Elemental sulfur of known allotropic forms can be used.

In a further embodiment, the term “sulfur” denotes a sulfide; i.e. compounds, containing the twice negatively charged sulfide anion S²⁻ (oxidation state −2), preferably an inorganic sulfide, preferably a metal sulfide. Alkali metal, alkaline earth metal and earth metal sulfides as well as sulfides of transition metals such as iron, zinc, copper sulfide or molybdenum sulfide are examples of such sulfides.

In a further embodiment, the term “sulfur” denotes an inorganic sulfate; i.e. oxygen compounds of sulfur in the form of twice negatively charged sulfate anion SO4²⁻ in which the sulfur is at oxidation state +6. Alkali and alkaline earth sulfates are preferably used.

In one embodiment, the content of the silica, carbon component and optional sulfur amounts to 0.1% to 60% by weight in relation to the total weight of the separator, preferably 0.5% to 50% by weight, further preferably 1% to 40% by weight.

In one embodiment, the weight ratio of silica to carbon component is 10:1 to 1:10, preferably 5:1 to 1:5, further preferably 2.5:1 to 1:2.5.

In one embodiment, the weight ratio of silica and carbon component to sulfur or the respective sulfur compound of oxidation state −2 or +6 amounts to 5:1, further preferably 10:1, more preferably 100:1.

In one embodiment of the inventive separator, the separator comprises a polymeric film.

In a further embodiment, the separator comprises interwoven polymeric fibers.

In a further embodiment, the separator comprises a fibrous nonwoven of non-woven polymeric fibers.

Preferably, the polymers used for the film or fibers do not conduct electrons.

The term “fibrous nonwoven” is used synonymously with terms such as “non-woven fabrics,” “non-woven material,” “knit mesh” or “felt.” The term “nonwoven”is also used in place of the term “unwoven.”

Preferably, the polymers for the polymeric film or the polymeric fibers are selected from among the group of polymers comprising polyacrylonitrile, polyolefin, polyester, polyimide, polyetherimide, polysulfone, polyamide and polyether.

Suitable polyolefins are preferably polyethylene, polypropylene, polytetrafluoro-ethylene or polyvinylidene fluoride.

Polyethylene terephthalates are preferential polyesters.

The polymeric film or the woven or non-woven polymeric fibers are preferably coated on one or both sides with a porous inorganic material.

In one preferred embodiment, the separator is designed as a fibrous nonwoven of non-woven polymeric fibers.

Particularly preferentially, the separator comprises a porous inorganic coating on or on and in the fibrous nonwoven.

A preferential separator is for example sold by the Evonik AG company in Germany under the trade name of “Separion®” as also disclosed above in the prior art. Methods for manufacturing such separators are known for example from EP 1 017 476 B1, WO 2004/021477 and WO 2004/021499.

In one embodiment, the polymeric fibers or the fibrous nonwoven of polymeric fibers is coated on one or both sides with an ion-conducting inorganic material.

In a further embodiment, the ion-conducting inorganic material is conductive to lithium ions in a temperature range of from −40° C. to 200° C., wherein the material used for the coating is at least one compound from the group consisting of oxides, phosphates, sulfates, titanates, silicates and aluminosilicates of at least one of the elements zircon, aluminum, silicon or lithium.

In a further embodiment, the ion-conducting material comprises or consists of alumina or zirconium oxide or alumina and zirconium oxide.

In one embodiment, the inorganic ion-conducting material preferably comprises particles, whereby preferably 90% (D90) (or more) have diameters no larger than 100 nm.

In principle, oversized pores and holes in separators used in secondary batteries can lead to an internal short circuit. In a dangerous reaction, the battery can self-discharge very quickly. Such large electrical currents can thereby occur that in the worst case, a closed battery cell can even explode. For this reason, the separator can crucially contribute to the safety, or the lack thereof respectively, of a lithium high-performance or lithium high-energy battery.

In improved embodiments, polymeric separators prevent any current from being transported through the electrolyte as of a certain temperature (the so-called “shut-down temperature” which is typically approx. 120° C.). This occurs due to the separator's pore structure collapsing at this temperature and closing all the pores. As ions can no longer be transported, the hazardous reaction which can lead to an explosion ceases. If, however, the cell continues to be heated due to external factors, the so-called “break-down temperature” will be exceeded at approx. 150-180° C. As of this temperature, conventional separators will melt, whereby they contract. This results in direct contact between the two electrodes at many points within the battery cell and thus to an internal short circuit over a large area. This leads to an uncontrolled reaction which can end with the cell exploding, respectively the developing pressure has to be dissipated by means of a pressure relief valve (e.g. a bursting disk), frequently amid signs of fire.

When a separator of the Separion® type comprising a fibrous nonwoven of non-woven polymeric fibers and an inorganic coating is used in a secondary battery, particularly a lithium ion battery, a shut-down can only occur when the polymeric structure of the substrate melts due to high temperature and penetrates into the pores of the inorganic material, thereby closing them. Break-down, however, does not occur in this separator since the inorganic particles ensure that the separator cannot melt completely. This thereby ensures that there is no operating states in which large-area short circuiting can occur. The type of nonwoven utilized, which exhibits a particularly well-suited combination of thickness and porosity, enables separators to be produced which meet the requirements placed on separators for high-performance batteries, particularly lithium high-performance batteries. Concurrently using oxidic particles precisely calibrated as to their particle size in producing the porous (ceramic) coating achieves a particularly high porosity to the finished separator, wherein the pores are still small enough to minimize any unwanted growth of “lithium whiskers” through the separator.

In one embodiment of the inventive separator, particularly a separator of the Separion® type, which in accordance with the invention additionally comprises a silica and a carbon component or a silica, a carbon component and sulfur at least partially, preferably substantially at oxidation state 0, −2 or +6, the growth of dendrites or whiskers can be further advantageously minimized.

Due to the high porosity combined with the thinness of the inventive separator, it is moreover possible to completely or at least nearly entirely impregnate the separator with the electrolyte such that there can be no dead spots in any individual area of the separator and thus in specific windings or layerings of the battery cells in which there is no electrolyte. This is in particular achieved in that by abiding by the oxidic particle size, the resulting separators are free or nearly free of closed pores into which electrolyte cannot penetrate. The inventive separators used in the invention have the further advantage of the conducting salt anions partially depositing on the inorganic surfaces of the separator material, which leads to improved dissociation and thus to improved ionic conductivity in the high-current range. A further, not insignificant advantage of the separator lies in its very good wettability. Due to the hydrophilic ceramic coating, electrolyte wetting takes place very rapidly, which likewise results in improved conductivity.

Inventive separators used for the inventive battery, preferably comprising a flexible fibrous nonwoven having a porous inorganic coating on and in said nonwoven, wherein the material of the nonwoven is selected from non-woven, nonelectro-conductive polymeric fibers, and further comprising a silica and a carbon component, are further additionally characterized by the fibrous nonwoven having a thickness of less than 30 μm, a porosity of more than 50%, preferably 50-97%, and a pore radius distribution in which at least 50% of the pores have a pore radius of 75 to 150 μm.

It is particularly preferential for the inventive separator to comprise a fibrous nonwoven which exhibits a thickness of 5 to 30 μm, preferably a thickness of 10 to 20 μm. Particularly advantageous is also the most homogenous possible fibrous nonwoven pore radius distribution as indicated above. Coupled with optimally harmonized oxidic particles of specific size, a maximized homogeneous pore radius distribution in the fibrous nonwoven leads to optimized separator porosity. The thickness of the substrate greatly influences the properties of the separator, since the flexibility on the one hand and the surface resistance on the other of the electrolyte-drenched separator depends on the thickness of the substrate. The thinness can achieve a particularly low electrical resistance to the separator in use with an electrolyte. The separator itself has a very high electrical resistance since it itself needs to have insulating properties. In addition, thinner separators allow greater packing density in a battery stack so that a larger amount of energy can be stored in the same volume.

Preferably the fibrous nonwoven has a porosity of 60-90%, particularly preferentially 70-90%. Porosity is thereby defined as the volume of the fibrous nonwoven (100%) minus the volume of the fibrous nonwoven's fibers; i.e. the percentage of the fibrous nonwoven volume not filled with material.

The volume of the fibrous nonwoven can thereby be calculated from the fibrous nonwoven's dimensions. The volume of the fibers yields from the measured weight of the fibrous nonwoven at issue and the density of the polymeric fibers. The high substrate porosity also enables a higher separator porosity, which is why the separator is able to absorb a higher volume of electrolyte. So as to obtain a separator having insulating properties, same preferably comprises nonelectro-conductive fibers of polymer as defined above as the polymeric fibers for the fibrous nonwoven which are preferably selected from among polyacrylonitrile (PAN), polyester such as e.g. polyethylene terephthalate (PET) and/or polyolefin (PO) such as e.g. polypropylene (PP) or polyethylene (PE) or mixtures of such polyolefins.

The polymeric fibers of the fibrous nonwoven preferably exhibit a diameter of from 0.1 to 10 μm, particularly preferentially from 1 to 4 μm.

Particularly preferential flexible fibrous nonwovens exhibit a surface weight less than 20 g/m², preferably 5 to 10 g/m².

Preferably the fibrous nonwoven is flexible and less than 30 μm thick.

In one embodiment, an inventive separator comprises a porous, electrically insulating ceramic coating, particularly on and in the polymeric film or on or in the polymeric fibers, preferably in the fibrous nonwoven of non-woven polymeric fibers.

Preferably, the porous inorganic coating on and in the film or the fibers, preferably in the fibrous nonwoven, comprises oxidic particles of the Li, Al, Si and/or Zr elements having an average particle size of 0.5 to 7 μm, preferentially 1 to 5 μm, and most particularly preferentially 1.5 to 3 μm.

It is particularly preferential for a separator according to the invention to comprise a porous inorganic coating on and in the film or the fibers, preferably on and in the fibrous nonwoven, which comprises alumina particles. These preferably have an average particle size of 0.5 to 7 μm, preferentially 1 to 5 μm most particularly preferentially 1.5 to 3 μm. In one embodiment, the alumina particles are adhered together by an oxide of the Zr or Si elements.

To achieve the highest porosity possible, it is preferable for more than 50% by weight and particularly preferably more than 80% by weight of all the particles to be within the above-cited limits for average particle size. As already described above, the maximum particle size is preferably less than ⅓ to ⅕ and particularly preferably not more than 1/10 of the thickness of the fibrous nonwoven used.

Preferably, a separator according to the invention exhibits a porosity of 30-80%, preferentially 40-75% and particularly preferentially 45-70%. Porosity hereby refers to accessible, i.e. open pores. Porosity can thereby be determined by the known method of mercury porosimetry or can be calculated from the volume and the density of the materials employed on the assumption that there are only open pores. The separators used for the inventive battery are also characterized in that they can exhibit tensile strength of at least 1 N/cm, preferably at least 3 N/cm, and most particularly preferentially 3 to 10 N/cm. The separators can preferably bend to any radius down to 100 mm, preferably down to 50 mm, and most particularly preferentially to a radius down to 1 mm without damage.

The high tensile strength and good bendability of a Separion®-type separator according to the invention has the advantage of the separator being able to accommodate the changes in electrode geometry which occur in the course of battery charging and discharging without being damaged. Bendability also has the advantage that commercially standardized wound cells can be produced using this separator. In such cells, the electrode/separator layers coil and contact at a standardized size.

In one embodiment, it is possible to design an inventive separator so as to have the form of a concave or convex sponge or cushion or the form of wires or a felt. This embodiment is well suited to compensating the volume changes in the battery. The respective manufacturing methods are known to those skilled in the art.

In a further embodiment, the polymeric fibrous nonwoven used in an inventive separator comprises a further polymer. Preferably, said polymer is disposed between the separator and the negative electrode and/or the separator and the positive electrode, preferably in the form of a polymeric layer.

In one embodiment, the separator is coated on one or both sides with said polymer.

Said polymer can be in the form of a porous membrane; i.e. a film, or in the form of a fibrous nonwoven, preferably in the form of a fibrous nonwoven of non-woven polymeric fibers.

Said polymers are preferably selected from among the group consisting of polyester, polyolefin, polyacrylonitrile, polycarbonate, polysulfone, polyethersulfone, polyvinylidene fluoride, polystyrene and polyetherimide.

Preferably the further polymer is a polyolefin. Polyethylene and polypropylene are preferential polyolefins.

Preferably the separator is coated with one or more layers of the further polymer, preferably polyolefin, which is preferably likewise a fibrous nonwoven; i.e. non-woven polymeric fibers.

Preferably a fibrous nonwoven of polyethylene terephthalate is used in the separator which is coated with one or more layers of the further polymer, preferably polyolefin, which is preferably likewise a fibrous nonwoven; i.e. non-woven polymeric fibers.

Particularly preferentially, the separator is of the above-described Separion type, whereby it is coated with one or more layers of the further polymer, preferably polyolefin, which is preferably likewise a fibrous nonwoven; i.e. non-woven polymeric fibers.

Coating with further polymers, preferably polyolefin, can be realized by gluing, laminating, a chemical reaction, welding or by mechanically connecting. Such polymer composites as well as methods for their manufacture are known from EP 1 852 926.

Preferably the fiber diameters of the polyethylene terephthalate nonwoven are greater than the fiber diameters of the further polymeric nonwoven, preferably the polyolefin nonwoven, which coats the separator on one or both sides.

Preferably the fibrous nonwoven made of polyethylene terephthalate then exhibits a greater pore diameter than the fibrous nonwoven made from the further polymers.

Preferably, the fibrous nonwovens used in the separator are made from nanofibers of the polymers employed, thereby forming fibrous nonwovens which exhibit high porosity at small pore diameters. This thus further reduces the risk of short circuit reactions.

The use of a polyolefin additionally to the polyethylene terephthalate ensures increased safety for the electrochemical cell as the pores of the polyolefin constrict upon unwanted or excessive heating of the cell and transport of charge through the separator is reduced and/or stopped. Should the temperature of the electrochemical cell increase to the extent that the polyolefin starts to melt, the polyethylene terephthalate effectively counteracts the fusing of the separator and thus an uncontrolled destruction of the electrochemical cell.

In one embodiment, the separator preferentially consists of or comprises a substrate which is permeable to material, wherein the substrate is coated on at least one side with an inorganic material, whereby preferably an organic material preferably designed as a fibrous nonwoven is used as the material-permeable substrate, wherein the organic material preferably comprises a polymer and particularly preferably a polymer selected from polyethylene terephthalate, whereby the organic material is coated with an inorganic ion-conducting material which preferably conducts ions in a temperature range of −40° C. to 200° C., wherein the inorganic ion-conducting material is preferably at least one compound from the group comprising oxides, phosphates, sulfates, titanates, silicates, aluminosilicates of at least one of the Zr, Al, Li elements, particularly zirconium oxide, and wherein the inorganic material preferably exhibits particles having diameters no larger than 100 nm, whereby the separator comprises at least one silica and at least one carbon component or, additionally to the silica or carbon component, sulfur which is at least partially, preferentially substantially, at an oxidation state of 0, −2 or +6.

In one embodiment of the separator, the at least one silica and the at least one carbon component or the at least one silica, the at least one carbon component and the sulfur at least partially, preferentially substantially, at an oxidation state of 0, −2 or +6, is provided

(α1) in the polymeric film; and/or

(α2) on the polymeric film; or

(β1) in the polymeric fibers; and/or

(β2) on the polymeric fibers; or

(γ1) in the ion-conducting inorganic material; and/or

(γ2) on the ion-conducting inorganic material.

### Battery

According to a second aspect, the invention relates to a lithium ion battery comprising the inventive separator.

The lithium ion battery at least comprises:

(i) a positive electrode;

(ii) a negative electrode;

(iii) a separator in accordance with the invention;

(iv) a non-aqueous electrolyte.

The terms “lithium ion battery” and “lithium ion secondary battery” are used synonymously. The terms also encompass the terms “lithium battery,” “lithium ion accumulator” and “lithium ion cell.” A lithium ion accumulator generally consists of a series of or series-connected individual lithium ion cells. This means that the term “lithium ion battery” is used as a collective term for the above-cited terms commonly used in the prior art.

### Electrode

The term “positive electrode” means the electrode able to absorb electrons upon the battery being connected to a load, e.g. an electric motor. It thus constitutes the cathode.

The term “negative electrode” means the electrode able to release electrons during operation. This electrode thus constitutes the anode.

### Positive Electrode

A cathode material comprising a lithium transition metal oxide is used for the lithium ion battery according to the invention.

In one embodiment of the electrochemical cell of the present invention, the positive electrode contains a lithium mixed oxide.

Preferably the mixed oxide contains one or more elements selected from among nickel, manganese and cobalt.

Such electrode material is known in the prior art. These oxides utilized for the positive electrode are commercially available or can be produced pursuant known methods.

In one embodiment, the positive electrode comprises lithium iron phosphate. The phosphate can also additionally contain Mn, Co or Ni, or combinations thereof.

In a further embodiment, the positive electrode comprises a lithium transition metal phosphate such as lithium manganese phosphate, lithium cobalt phosphate or lithium nickel phosphate.

The positive electrode can also contain mixtures of two or more of the cited substances.

The lithium compound of the positive electrode is preferably in the form of nanoparticles.

The nanoparticles can take any shape; i.e. they can be more or less spherical or elongated.

In one embodiment, the lithium compound exhibits a particle size measured as a D90 value of less than 15 μm. Preferably, the particle size is smaller than 10 μm.

In a further embodiment, the lithium compound exhibits a particle size measured as a D90 value of between 0.005 μm and 10 μm. In a further embodiment, the lithium compound exhibits a particle size measured as a D90 value of less than 10 μm, whereby the D50 value is 4 μm±2 μm and the D10 value is less than 1.5 μm.

The indicated values are determined by measuring using static laser scattering (laser diffraction, laser diffractometry) as known in the prior art.

It is furthermore also possible for the lithium compound to contain carbon to increase conductivity. Such compounds can be produced according to known methods, for example coating with carbon compounds such as acrylic acid or ethyl glycol. Pyrolysis then follows, for example at a temperature of 2500° C.

### Negative Electrode

The negative electrode can be produced from a plurality of materials known in the prior art for use in a lithium ion battery. In principle, all materials capable of forming intercalation compounds with lithium can be used.

For example, the negative electrode can contain lithium metal or lithium in the form of an alloy, either in the form of a film, a mesh or in the form of particles held together by an appropriate binding agent.

The use of lithium metal oxides such as lithium titanium oxide is likewise possible.

Suitable materials for the negative electrode also include graphite, synthetic graphite, carbon black, mesocarbon, doped carbon and fullerene. Niobium pentoxide, tin alloys, titanium dioxide, tin dioxide and silicon can likewise be used.

The materials used for the positive electrode, as also for the negative electrode, are preferably held together by a binding agent which holds these materials to the electrode. Polymeric binding agents can for example be used. Polyvinylidene fluoride, polyethylene oxide, polyethylene, polypropylene, polytetrafluoroethylene, polyacrylate, ethylene-propylene-diene monomer copolymer and mixtures and co-polymers thereof can for example be used as the binding agent.

Particularly the inventive use of silica preferably in the form of a xerogel or in the form of xerogels can have a positive effect on the anode, particularly the preserving of the solid electrolyte interface layer (SEI layer). As is known, this layer prevents electrolyte components from penetrating the anode and these components from reacting with lithium. When this layer is damaged, uncontrolled igniting of the anode material can follow as a consequence, particularly when the latter comprises carbon. Suppressing or minimizing the formation of dendrites on the anode also suppresses or minimizes corresponding damage to the SEI layer, which is extremely advantageous with respect to the safety and longevity of the inventive battery.

### Non-Aqueous Electrolyte

Suitable electrolytes for the inventive battery are known from the prior art. The electrolytes preferably contain a liquid and a conducting salt. Preferably the liquid is a solvent for the conducting salt. Preferably the electrolyte is an electrolytic solution.

Suitable solvents are preferably inert. Suitable solvents include for example solvents such as ethyl carbonate, propylene carbonate, butylene carbonate, dimethyl carbonate, diethyl carbonate, ethyl methyl carbonate, methyl propyl carbonate, butyl methyl carbonate, ethyl propyl carbonate, dipropyl carbonate, cyclopentanones, sulfolanes, dimethyl sulfoxide, 3-methyl-1,3-oxazolidine-2-one, γ-butyrolactone, 1,2-diethoxymethane, tetrahydrofuran, 2-methyltetrahydrofuran, 1,3-dioxolane, methyl acetate, ethyl acetate, nitromethane and 1,3-propansultone.

In one embodiment, ionic liquids can also be used.

Ionic liquids are known from the prior art and contain only ions. Examples of applicable cations, which in particular can be alkylated, are imidazolium, pyridinium, pyrrolidinium, guanidinium, uronium, thiuronium, piperidinium, morpholinium, sulfonium, ammonium and phosphonium cations. Examples of applicable anions are halide, tetrafluoroborate, trifluoroacetate, triflate, hexafluorophosphate, phosphinate and tosylate anions.

N-methyl-N-propyl-piperidinium-bis(trifluoro-methylsulfonyl)imide, N-methyl-N-butyl-pyrrolidinium-bis(trifluoromethylsulfonyl)imide, N-butyl-N-trimethyl-ammonium-5 bis-(trifluoromethylsulfonyl)imide, triethylsulfonium-bis(trifluoromethylsulfonyl)imide and N,N-diethyl-N-methyl-N-(2-methoxy-ethyl)-ammonium-bis(trifluormethylsulfonyl)-imide are cited as illustrative ionic liquids.

Two or more of the above-cited liquids can be used.

Preferential conducting salts are lithium salts exhibiting inert anions and which are non-toxic. Suitable lithium salts are for example lithium hexafluorophosphate, lithium hexafluoroarsenate, lithium bis(trifluoromethylsulfonyl)imide, lithium trifluoromethanesulfonate, lithium tris(trifluoromethylsulfonyl)methide, lithium tetrafluoroborate, lithium perchlorate, lithium tetrachloroaluminate, lithium chloride, lithium bis(oxalato)borate, lithium difluoro(oxalato)borate and mixtures of two or more of these salts.

### Separator and Battery Manufacture

The inventive separator can be manufactured pursuant known methods.

All methods with which it is possible to incorporate a silica and a carbon component and optionally sulfur which is at least partially, preferentially substantially, at an oxidation state of 0, −2 or +6 into a material and/or deposit onto a material capable of being used as a separator in a lithium ion battery can be used.

The silica, carbon component and optional sulfur which is at least partially, preferentially substantially, at an oxidation state of 0, −2 or +6 are preferably used in powder form.

In one embodiment, the at least one silica, the at least one carbon component and the optional sulfur which is at least partially, preferentially substantially, at an oxidation state of 0, −2 or +6 are used in the form of a mixture.

In one embodiment, it is preferred for the at least one silica, the at least one carbon component and the optional sulfur which is at least partially, preferentially substantially, at an oxidation state of 0, −2 or +6 to be mixed with a material to be used as the separator and the mixture processed into a separator which then contains the at least one silica, the at least one carbon component and the optional sulfur which is at least partially, preferentially substantially, at an oxidation state of 0, −2 or +6.

In one embodiment, it is preferred for the at least one silica, the at least one carbon component and the optional sulfur which is at least partially, preferentially substantially, at an oxidation state of 0, −2 or +6, to be mixed with a polymer and the mixture extruded into a polymeric film or a polymeric fiber, whereby the polymeric film or the polymeric fiber contains the at least one silica, the at least one carbon component and the optional sulfur which is at least partially, preferentially substantially, at an oxidation state of 0, −2 or +6.

In a further embodiment, it is preferred for the at least one silica, the at least one carbon component and the optional sulfur which is at least partially, preferentially substantially, at an oxidation state of 0, −2 or +6 to be deposited onto a polymeric film or a polymeric fiber in paste form, preferably containing suitable binding agents, so that the at least one silica, the at least one carbon component and the optional sulfur which is at least partially, preferentially substantially, at an oxidation state of 0, −2 or +6 constitute a coating on the polymeric film or the polymeric fiber.

In a further embodiment, it is preferred for the at least one silica, the at least one carbon component and the optional sulfur which is at least partially, preferentially substantially, at an oxidation state of 0, −2 or +6 to be mixed with a ceramic material and this mixture deposited onto a polymeric film or a polymeric fiber in paste form, preferably containing suitable binding agents, whereby the resultant ceramic coating contains the at least one silica, the at least one carbon component and the optional sulfur which is at least partially, preferentially substantially, at an oxidation state of 0, −2 or +6. Preferably the ceramic (inorganic) material is ion-conductive, preferably ion-conductive with respect to lithium ions.

In a further embodiment, it is preferred for the at least one silica, the at least one carbon component and the optional sulfur which is at least partially, preferentially substantially, at an oxidation state of 0, −2 or +6 to be deposited in paste form, preferably containing suitable binding agents, on a ceramic layer of a separator, whereby a polymeric film or a polymeric fiber is coated with the ceramic layer such that the at least one silica, the at least one carbon component and the optional sulfur which is at least partially, preferentially substantially, at an oxidation state of 0, −2 or +6 constitutes a coating on the ceramic layer of the separator.

Drying steps can follow the above processing steps where applicable.

In a further embodiment, it is also preferential for at least one silica and at least one carbon component and the optional sulfur which is at least partially, preferentially substantially, at an oxidation state of 0, −2 or +6, to be processed separately from each other.

The manufacturing of the lithium ion battery according to the invention can thus preferably ensue in that the positive electrode is produced by depositing a suitable lithium compound on the electrode as powder and compacting it into a thin film, if need be utilizing a binding agent. The negative electrode can be laminated onto the positive electrode, whereby the separator has previously been laminated in the form of a film on the negative or the positive electrode. It is also possible to process the positive electrode, the separator and the negative electrode at the same time by jointly laminating them.

### Use of the Inventive Battery

According to a third aspect, the invention relates to the use of a battery in accordance with the invention.

The inventive battery can provide high energy density and capacitance at high voltage, wherein the battery exhibits good stability even at high voltage output. It can thus preferably be used to supply energy to portable electronic devices, tools, electrically operated automobiles and hybrid-drive automobiles.

Preferably, the inventive lithium battery can be operated at ambient temperatures between −40° C. and +100° C.

Preferential discharge currents of an inventive battery are greater than 100 A, preferably greater than 200 A, preferably greater than 300 A, further preferentially greater than 400 A.

### Use of the Inventive Separator

According to a fourth aspect, the present invention relates to the use of at least one silica and at least one carbon component as well as, in addition to the least one silica and at least one carbon component, optionally sulfur which is at least partially, preferentially substantially, at an oxidation state of 0, −2 or +6, in a lithium ion battery.

In one embodiment, the invention relates to the use of at least one silica and at least one carbon component as well as, in addition to the least one silica and at least one carbon component, optionally sulfur which is at least partially, preferentially substantially, at an oxidation state of 0, −2 or +6, in a separator of a lithium ion battery.

In one embodiment, the invention relates to the use of at least one silica and at least one carbon component as well as, in addition to the least one silica and at least one carbon component, optionally sulfur which is at least partially, preferentially substantially, at an oxidation state of 0, −2 or +6, in a separator of a lithium ion battery for

(j) diminishing Li dendrites or whisker formation in the separator;

(jj) binding water and/or hydrogen fluoride in the lithium ion battery;

(jjj) increasing the dimensional stability of the separator or the separator and the lithium ion battery;

(jjjj) absorbing gas in the lithium ion battery.

1-15. (canceled)

16. A separator for a lithium ion battery which separates the positive and the negative electrode of the lithium ion battery from one another and which is permeable to lithium ions, the separator comprising:
at least one silica; and
at least one carbon component.

17. The separator according to claim 16, wherein the at least one silica is comprised of a xerogel.

18. The separator according to claim 16, further comprising sulfur at an oxidation state of 0, −2 or +6.

19. The separator according to claim 16, wherein the content of the silica and the carbon component amounts to 0.1% to 60% by weight in relation to the total weight of the separator.

20. The separator according to claim 18, wherein the content of the silica, the carbon component, and the sulfur amounts to 0.1% to 60% by weight in relation to the total weight of the separator.

21. The separator according to claim 16, wherein the weight ratio of silica to carbon component is in a range from 5:1 to 1:5.

22. The separator according to claim 16, further comprising at least one of (a) a polymeric film, (b) interwoven polymeric fibers, and (c) a fibrous nonwoven material of non-woven polymeric fibers.

23. The separator according to claim 22, wherein the film or fibers are comprised of a polymer selected from the group consisting of: polyacrylonitrile polyolefin, polyester, polyimide, polyetherimide, polysulfone, polyamide, and polyether.

24. The separator according to claim 22, wherein the polymeric film or the polymeric fibers or the fibrous nonwoven of polymeric fibers are coated on one or both sides with an ion-conducting inorganic material.

25. The separator according to claim 24, wherein the ion-conducting inorganic material is conductive to lithium ions in a temperature range of from −40° C. to 200° C., wherein the material used for the coating is at least one compound from the group consisting of oxides, phosphates, sulfates, titanates, silicates, and aluminosilicates of at least one of the elements zircon, aluminum, silicon, or lithium.

26. The separator according to claim 24, wherein the ion-conducting material comprises at least one of alumina and zirconium oxide.

27. The separator according to claim 24, wherein the inorganic ion-conducting material exhibits at least 90% of the particles (D90) having diameters no larger than 100 nm.

28. The separator according to claim 16, wherein the separator comprises a material-permeable substrate, wherein the substrate is coated on at least one side with an inorganic material.

29. The separator according to claim 28, wherein the material-permeable substrate is comprised of an organic material.

30. The separator according to claim 29, wherein the organic material is a fibrous nonwoven material.

31. The separator according to claim 30, wherein the organic material is comprised of a polymer.

32. The separator according to claim 24, wherein the at least one silica and the at least one carbon component is provided:
(α1) in the polymeric film and/or (α2) on the polymeric film; or
(β1) in the polymeric fibers and/or (β2) on the polymeric fibers; or
(γ1) in the ion-conducting inorganic material and/or (γ2) on the ion-conducting inorganic material.

33. A lithium ion battery comprising:
a positive electrode;
a negative electrode;
a separator as defined in claim 16;
a non-aqueous electrolyte.

34. A method comprising:
using a lithium ion battery according to claim 34 to supply energy to at least one of portable electronic devices, tools, electrically operated automobiles, and hybrid-drive automobiles.

35. A method comprising:
using at least one silica and at least one carbon component and in a separator of a lithium ion battery to at least one of:
diminish Li dendrites or whisker formation in the separator;
bind water and/or hydrogen fluoride in the lithium ion battery;
increase the dimensional stability of the separator or of the separator and the lithium ion battery; and
absorb gas in the lithium ion battery.
